(19) United States
(12) Patent Application Publication
(10) Pub. No.: US 2024/0030456 A1
(43) Pub. Date: Jan. 25, 2024

(54) PROTECTIVE CARBON COATINGS FOR ELECTRODE ASSEMBLY

(71) Applicant: GM GLOBAL TECHNOLOGY OPERATIONS LLC, Detroit, MI (US)

(72) Inventors: Mengyuan CHEN, Madison Heights, MI (US); Xiaosong HUANG, Novi, MI (US); Bradley R. FRIEBERG, Farmington Hills, MI (US); Roland J. KOESTNER, Webster, NY (US)

(73) Assignee: GM GLOBAL TECHNOLOGY OPERATIONS LLC, Detroit, MI (US)

(21) Appl. No.: 17/869,471

(22) Filed: Jul. 20, 2022

(51) Int. Cl. H01M 4/66; H01M 4/62; H01M 10/0525

(52) U.S. Cl. CPC H01M 4/663; H01M 4/626; H01M 4/667; H01M 10/0525

(57) ABSTRACT

The present disclosure provides an electrode assembly for use in an electrochemical cell that cycles lithium ions. The electrode assembly includes a current collector, an electroactive material layer disposed parallel with the current collector, and a protective coating disposed between the current collector and the electroactive material layer. The electroactive material layer is defined by a plurality of electroactive material particles. At least a portion of the electroactive material particles of the plurality of electroactive material particles includes a protective particle coating. The protective particle coating is a carbon coating that includes a first carbonaceous material. The protective coating is a carbon layer that includes a second carbonaceous material. The first and second carbonaceous materials are independently selected from the group consisting of: graphite, graphene, carbon black, soft carbon, hard carbon, carbon fibers, carbon nanotubes, mesoporous carbon materials, biomass derived carbon materials, and combinations thereof.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator filled with a liquid or solid electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte (or solid-state separator), the solid-state electrolyte (or solid-state separator) may physically separate the electrodes so that a distinct separator is not required.

Many different materials may be used to create components for a lithium-ion battery. For example, in various aspects, positive electrodes include nickel-rich electroactive materials (e.g., greater than or equal to about 0.6 mole fraction on transition metal lattice), such as NMC (LiNiₓCo_{y}Mn_{1-x-y}O₂, where 0.6≤x≤1, 0≤y≤0.4) and/or NCA (LiNiₓCo_{y}Al_{1-x-y}O₂, where 0.6≤x≤1, 0≤y≤0.4) and/or NCMA (LiNiₓCo_{y}Mn_{z}Al_{1-x-y-z}O₂, where 0.6≤x≤1, 0≤y≤0.4, 0≤z≤0.4), which are capable of providing improved capacity capability (e.g., greater than 200 mAh/g) while allowing for additional lithium extraction without compromising the structural stability of the positive electrode. Such materials, however, are often thermally unstable. For example, the reduction of Ni⁴⁺ to Ni²⁺ during heating can release oxygen that can cause severe thermal event by reacting with flammable electrolytes. Further, metal oxides precipitated from electroactive materials during cell cycling and/or proton generation from the electrochemical oxidation of the electrolyte can react with current collectors, and in particular, aluminum, causing chemical corrosion of the current collectors. Accordingly, it would be desirable to develop improved materials, and methods of making and using the same, that can address these challenges.

### SUMMARY

This section provides a general summary of the disclosure, and is not a comprehensive disclosure of its full scope or all of its features.

The present disclosure relates to electrochemical cells including protective carbon coatings (for example, protective current collector coatings and/or protective electroactive material particle coatings), and to methods of making and using the same.

In various aspects, the present disclosure provides an electrode assembly for use in an electrochemical cell that cycles lithium ions. The electrode assembly may include a current collector, a protective coating disposed near or adjacent to a surface of the current collector, and an electroactive material layer disposed near or adjacent to a surface of the protective coating opposite to the current collector. The protective coating may be a carbon layer that includes a carbonaceous material selected from the group consisting of: graphite, graphene, carbon black, soft carbon, hard carbon, carbon fibers, carbon nanotubes, mesoporous carbon materials, biomass-derived carbon materials, and combinations thereof.

In one aspect, the protective coating may be a continuous coating covering greater than or equal to about 85% of the surface of the current collector.

In one aspect, the protective coating may have an average thickness greater than 0 micrometer to less than or equal to about 20 micrometers.

In one aspect, the current collector may include an electrically conductive material selected from the group consisting of: aluminum (Al), copper (Cu), nickel (Ni), titanium (Ti), stainless steel (SS), and combinations thereof.

In one aspect, the electroactive material layer may be defined by a plurality of electroactive material particles and at least a portion of the electroactive material particles of the plurality may include a protective particle coating.

In one aspect, the carbonaceous material may be a first carbonaceous material, and the protective particle coating may be a carbon coating that includes a second carbonaceous material. The second carbonaceous material may be selected from the group consisting of: graphite, graphene, carbon black, soft carbon, hard carbon, carbon fibers, carbon nanotubes, mesoporous carbon materials, biomass derived carbon materials, and combinations thereof.

In one aspect, the first carbonaceous material may be the same as the second carbonaceous material.

In one aspect, the protective particle coating may be a continuous or discontinuous coating that covers greater than 0% to less than or equal to about 100% of a total surface area of each electroactive material particle of the plurality of electroactive material particles.

In one aspect, the protective particle coating may have an average thickness greater than 0 nanometers to less than or equal to about 1,000 nanometers.

In one aspect, the electroactive material particles of the plurality of electroactive material particles include a nickel-rich electroactive material represented by:

LiM¹ₓM²_{y}M³_{z}M⁴_{(1-x-y-z)}O₂

where M¹, M², M³, and M⁴ are each a transition metal independently selected from the group consisting of: nickel (Ni), manganese (Mn), cobalt (Co), aluminum (Al), iron (Fe), and combinations thereof, where 0≤x≤1, 0≤y≤1, and 0≤z≤1.

In one aspect, the electroactive material layer may include greater than or equal to about 50 wt. % to less than or equal to about 99 wt. % of an electroactive material, and greater than or equal to about 0.5 wt. % to less than or equal to about 30 wt. % of a conductive additive. The conductive additive may include a first conductive additive having a first aspect ratio and a second conductive additive having a second aspect ratio, the first and second aspect ratios being different.

In one aspect, the electroactive material layer may include greater than or equal to about 50 wt. % to less than or equal to about 99 wt. % of an electroactive material, and greater than or equal to about 0.2 wt. % to less than or equal to about 15 wt. % of a polymer dispersant additive. The polymer dispersant additive may be selected from the group consisting of: acid-functionalized polyvinylidene fluoride (PVDF) co-polymers, acid-functionalized sulfonated poly(p-phenylene), acid-functionalized polyvinylpyridine, and combinations thereof.

In various aspects, the present disclosure provides an electrode assembly for use in an electrochemical cell that cycles lithium ions. The electrode assembly may include a current collector and an electroactive material layer disposed near or adjacent to a surface of the current collector. The electroactive material layer may be defined by a plurality of electroactive material particles, where at least a portion of the electroactive material particles of the plurality of electroactive material particles include a protective particle coating. The protective particle coating may be a carbon coating that includes a carbonaceous material selected from the group consisting of: graphite, graphene, carbon black, soft carbon, hard carbon, carbon fibers, carbon nanotubes, mesoporous carbon materials, biomass derived carbon materials, and combinations thereof.

In one aspect, the protective particle coating may be a continuous or discontinuous coating that covers greater than 0% to less than or equal to about 100% of a total surface area of the at least a portion of the electroactive material particles The protective particle coating may have an average thickness greater than 0 nanometers to less than or equal to about 1,000 nanometers.

In one aspect, the carbonaceous material may be a first carbonaceous material, and the surface of the current collector may include a protective coating. The protective coating may be a continuous carbon coating that covers greater than or equal to about 85% of the surface of the current collector. The protective coating may include a second carbonaceous material selected from the group consisting of: graphite, graphene, carbon black, soft carbon, hard carbon, carbon fibers, carbon nanotubes, mesoporous carbon materials, biomass derived carbon materials, and combinations thereof. The second carbonaceous material may be the same as or different from the first carbonaceous material.

In one aspect, the protective coating may have an average thickness greater than 0 micrometers to less than or equal to about 20 micrometers.

In various aspects, the present disclosure provides an electrode assembly for use in an electrochemical cell that cycles lithium ions. The electrode assembly may include a current collector, an electroactive material layer disposed parallel with the current collector, and a protective coating disposed between the current collector and the electroactive material layer. The electroactive material layer may be defined by a plurality of electroactive material particles and conductive additive dispersed with the electroactive material particles. At least a portion of the electroactive material particles of the plurality of electroactive material particles may include a protective particle coating. The protective particle coating may be a carbon coating that includes a first carbonaceous material. The conductive additive conductive additive may include a first conductive additive having a first aspect ratio and a second conductive additive having a second aspect ratio, where the first and second aspect ratios are different. The protective coating may be a carbon layer that includes a second carbonaceous material. The first and second carbonaceous materials may be independently selected from the group consisting of: graphite, graphene, carbon black, soft carbon, hard carbon, carbon fibers, carbon nanotubes, mesoporous carbon materials, biomass derived carbon materials, and combinations thereof.

In one aspect, the protective particle coating may be a continuous or discontinuous coating that covers greater than 0% to less than or equal to about 100% of a total surface area of the as least a portion of the electroactive material particles. The protective particle coating may have an average thickness greater than 0 nanometers to less than or equal to about 1,000 nanometers.

In one aspect, the protective coating may be a continuous coating that covers greater than or equal to about 85% of the surface of the current collector. The protective coating may have an average thickness greater than 0 micrometers to less than or equal to about 20 micrometers.

In one aspect, the electroactive material layer may include greater than or equal to about 50 wt. % to less than or equal to about 99 wt. % of the electroactive material particles, greater than or equal to about 0.5 wt. % to less than or equal to about 30 wt. % of the conductive additive, and greater than or equal to about 0.2 wt. % to less than or equal to about 15 wt. % of a polymer dispersant additive. The polymer dispersant additive may be selected from the group consisting of: acid-functionalized polyvinylidene fluoride (PVDF) co-polymers, acid-functionalized sulfonated poly(p-phenylene), acid-functionalized polyvinylpyridine, and combinations thereof.

Corresponding reference numerals indicate corresponding parts throughout the several views of the drawings.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic of an example electrochemical battery cell including a protective current collector coating and/or a protective electroactive material particle coating in accordance with various aspects of the present disclosure;

FIG. 2 is an illustration of an example protective electroactive material particle coating in accordance with various aspects of the present disclosure;

FIG. 3A is a graphical illustration demonstrating heat generation of an example cell including a protective current collector coating in accordance with various aspects of the present disclosure;

FIG. 3B is a graphical illustration demonstrating heat generation of an example cell including a protective current collector coating in accordance with various aspects of the present disclosure;

FIG. 3C is a graphical illustration demonstrating the heat generation of example cells including a protective current collector coating in accordance with various aspects of the present disclosure; and

FIG. 3D is a graphical illustration demonstrating the capacity retention of an example cell including a protective current collector coating in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates both exactly or precisely the stated numerical value, and also, that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology relates to electrochemical cells including protective carbon coatings (for example, protective current collector coatings and/or protective electroactive material particle coatings), and also, to methods of forming and using the same. Such cells can be used in vehicle or automotive transportation applications (e.g., motorcycles, boats, tractors, buses, motorcycles, mobile homes, campers, and tanks). However, the present technology may also be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples detail below include a single positive electrode cathode and a single anode, the skilled artisan will recognize that the present teachings also extend to various other configurations, including those having one or more cathodes and one or more anodes, as well as various current collectors with electroactive layers disposed on or adjacent to one or more surfaces thereof.

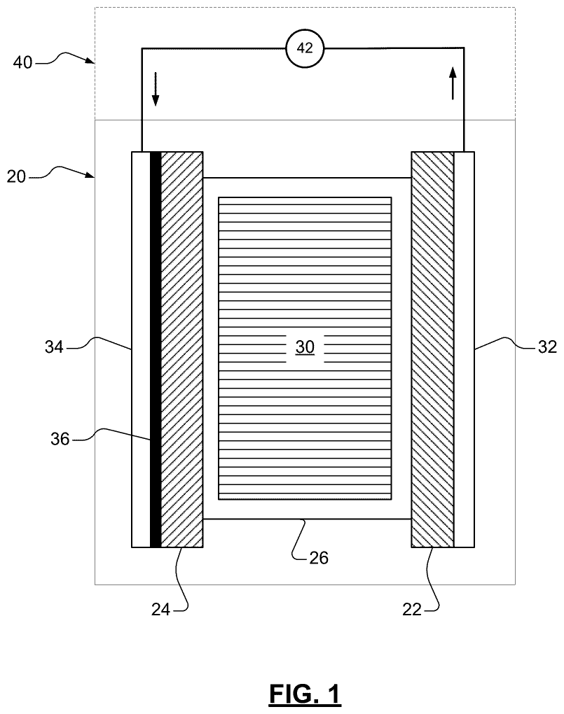

An exemplary and schematic illustration of an electrochemical cell (also referred to as a battery) 20 is shown in FIG. 1. The battery 20 includes a negative electrode 22 (e.g., anode), a positive electrode 24 (e.g., cathode), and a separator 26 disposed between the two electrodes 22, 24. The separator 26 provides electrical separation-prevents physical contact-between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and/or the positive electrode 24, so as to form a continuous electrolyte network. In certain variations, the separator 26 may be formed by a solid-state electrolyte or a semi-solid-state electrolyte (e.g., gel electrolyte). For example, the separator 26 may be defined by a plurality of solid-state electrolyte particles. In the instance of solid-state batteries and/or semi-solid-state batteries, the positive electrode 24 and/or the negative electrode 22 may include a plurality of solid-state electrolyte particles. The plurality of solid-state electrolyte particles included in, or defining, the separator 26 may be the same as or different from the plurality of solid-state electrolyte particles included in the positive electrode 24 and/or the negative electrode 22.

A first current collector 32 (e.g., a negative current collector) may be positioned at or near the negative electrode 22. The first current collector 32 together with the negative electrode 22 may be referred to as a negative electrode assembly. Although not illustrated, the skilled artisan will appreciate that, in certain variations, negative electrodes 22 (also referred to as negative electroactive material layers) may be disposed on one or more parallel sides of the first current collector 32. Similarly, the skilled artisan will appreciate that, in other variations, a negative electroactive material layer may be disposed on a first side of the first current collector 32, and a positive electroactive material layer may be disposed on a second side of the first current collector 32. In each instance, the first current collector 32 may be a metal foil, metal grid or screen, or expanded metal comprising aluminum (Al), copper (Cu), nickel (Ni), titanium (Ti), stainless steel (SS), or any other appropriate electrically conductive material known to those of skill in the art.

A second current collector 34 (e.g., a positive current collector) may be positioned at or near the positive electrode 24. The second current collector 34 together with the positive electrode 24 may be referred to as a positive electrode assembly. Although not illustrated, the skilled artisan will appreciate that, in certain variations, positive electrodes 24 (also referred to as positive electroactive material layers) may be disposed on one or more parallel sides of the second current collector 34. Similarly, the skilled artisan will appreciate that, in other variations, a positive electroactive material layer may be disposed on a first side of the second current collector 34, and a negative electroactive material layer may be disposed on a second side of the second current collector 34. In each instance, the second electrode current collector 34 may be a metal foil, metal grid or screen, or expanded metal comprising aluminum (Al), copper (Cu), nickel (Ni), titanium (Ti), stainless steel (SS), or any other appropriate electrically conductive material known to those of skill in the art. The first and second electrode current collectors 32, 34 may comprise the same or different electrically conductive materials.

In certain variations, one or more protective coatings may be disposed near or adjacent to one or more surfaces of the first current collector 32 and/or the second current collector 34. For example, as illustrated, a protective coating 36 may be disposed near or adjacent to a first surface of the second current collector 36 that opposes the positive electrode 24. That is, the protective coating 36 may be disposed between the second current collector 34 and the positive electrode 24. In certain instances, the protective coating 36 may be prepared using a magnetron sputtering process, a spreading process, a carbonization process, a chemical vapor deposition (CVD) process, a roller-and-heat treatment process, a dip coating process, a blade casting process, a drop casting and annealing process, a solution casting process, an electro-reduction reaction process, and/or an electron-beam deposition process. In each instance, the protective coating 36 may be substantially continuous covering greater than or equal to about 85%, optionally greater than or equal to about 90%, optionally greater than or equal to about 95%, optionally greater than or equal to about 98%, optionally greater than or equal to about 99%, and in certain aspects, optionally greater than or equal to about 99.5%, of a total surface area of the first surface of the second current collector 36.

The protective coating 36 may be a carbon coating comprising a carbonaceous material selected from the group consisting of: graphite, graphene, carbon black, soft carbon, hard carbon, carbon fibers, carbon nanotubes, mesoporous carbon materials, biomass derived carbon materials, and combinations thereof, and may have an average thickness greater than or equal to about 0 micrometer (μm) to less than or equal to about 20 μm, and in certain aspects, optionally greater than or equal to about 1 μm to less than or equal to about 2 μm. The protective coating 36 may help to limit and/or mitigate heat generation that often results from the reaction of the electrically conductive material(s) (e.g., aluminum) of the second electrode current collector 34 with metal oxides precipitated from, for example, positive electroactive materials defining the positive electrode 24. The protective coating 36 may also help to reduce chemical corrosion of the second electrode current collector 34, for example, as resulting from electrochemical oxidation of the electrolyte 30. The protective coating 36 may also help to improve the adhesion of the second electrode current collector 34 to the positive electrode, as well as inhibit or reduce cell polarization and short circuit caused by dendrite growth. Further still, the protective coating 36 may also help to reduce the electronic contact resistance at the positive electrode 24 to positive electrode current collector 34 interface. For example, a protective coating (such as a conformal carbon coating) on a current collector (comprising, for example, aluminum) may reduce the measured contact resistance fivefold (for example, from about 0.40 ohm-cm² to about 0.09 ohm-cm², where the bulk electronic resistivity was optimized at 1.5 mohm-cm).

In each instance, the first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34). The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the present technology also applies to solid-state batteries and/or semi-solid state batteries that include solid-state electrolytes and/or solid-state electrolyte particles and/or semi-solid electrolytes and/or solid-state electroactive particles that may have different designs as known to those of skill in the art.

The size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. For example, in certain aspects, the electrolyte 30 may be a non-aqueous liquid electrolyte solution (e.g., >1 M) that includes a lithium salt dissolved in an organic solvent or a mixture of organic solvents. Numerous conventional non-aqueous liquid electrolyte 30 solutions may be employed in the battery 20.

A non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof. These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC), vinylene carbonate (VC), and the like), linear carbonates (e.g., dimethyl carbonate (DMC), diethyl carbonate (DEC), ethylmethylcarbonate (EMC), and the like), aliphatic carboxylic esters (e.g., methyl formate, methyl acetate, methyl propionate, and the like), γ-lactones (e.g., γ-butyrolactone, γ-valerolactone, and the like), chain structure ethers (e.g., 1,2-dimethoxyethane, 1-2-diethoxyethane, ethoxymethoxyethane, and the like), cyclic ethers (e.g., tetrahydrofuran, 2-methyltetrahydrofuran, 1,3-dioxolane, and the like), sulfur compounds (e.g., sulfolane), and combinations thereof.

The porous separator 26 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic material and a heat-resistant material. For example, the separator 26 may also be admixed with the ceramic material and/or the heat-resistant material, or one or more surfaces of the separator 26 may be coated with the ceramic material and/or the heat-resistant material. In certain variations, the ceramic material and/or the heat-resistant material may be disposed on one or more sides of the separator 26. The ceramic material may be selected from the group consisting of: alumina (Al₂O₃), silica (SiO₂), and combinations thereof. The heat-resistant material may be selected from the group consisting of: Nomex, Aramid, and combinations thereof.

Various conventionally available polymers and commercial products for forming the separator 26 are contemplated, as well as the many manufacturing methods that may be employed to produce such a microporous polymer separator 26. In each instance, the separator 26 may have an average thickness greater than or equal to about 1 μm to less than or equal to about 50 μm, and in certain instances, optionally greater than or equal to about 1 μm to less than or equal to about 20 μm.

In various aspects, the porous separator 26 and/or the electrolyte 30 disposed in the porous separator 26 as illustrated in FIG. 1 may be replaced with a solid-state electrolyte (“SSE”) and/or semi-solid-state electrolyte (e.g., gel) that functions as both an electrolyte and a separator. For example, the solid-state electrolyte and/or semi-solid-state electrolyte may be disposed between the positive electrode 24 and negative electrode 22. The solid-state electrolyte and/or semi-solid-state electrolyte facilitates transfer of lithium ions, while mechanically separating and providing electrical insulation between the negative and positive electrodes 22, 24. By way of non-limiting example, the solid-state electrolyte and/or semi-solid-state electrolyte may include a plurality of fillers, such as LiTi₂(PO₄)₃, LiGe₂(PO₄)₃, Li₇La₃Zr₂O₁₂, Li₃xLa_{2/3}-xTiO₃, Li₃PO₄, Li₃N, Li₄GeS₄, LiioGeP₂S₁₂, Li₂S—P₂S₅, Li₆PS₅Cl, Li₆PS₅Br, Li₆PS₅I, Li₃OCl, Li_{2.99} Ba_{0.005}ClO, or combinations thereof. The semi-solid-state electrolyte may include a polymer host and a liquid electrolyte. The polymer host may include, for example, polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof. In certain variations, the semi-solid or gel electrolyte may also be found in the positive electrode 24 and/or the negative electrodes 22. In each instance, the solid-state electrolyte and/or semi-solid-state electrolyte includes the electrolyte additive as detailed above.

The negative electrode 22 (also referred to as a negative electroactive material layer) is formed from a lithium host material that is capable of functioning as a negative terminal of a lithium-ion battery. In various aspects, the negative electrode 22 may be defined by a plurality of negative electroactive material particles. Such negative electroactive material particles may be disposed in one or more layers so as to define the three-dimensional structure of the negative electrode 22. The electrolyte 30 may be introduced, for example after cell assembly, and contained within pores of the negative electrode 22. For example, in certain variations, the negative electrode 22 may include a plurality of solid-state electrolyte particles. In each instance, the negative electrode 22 (including the one or more layers) may have an average thickness greater than or equal to about 0 nanometer (nm) to less than or equal to about 500 μm, optionally greater than or equal to about 1 μm to less than or equal to about 500 μm, and in certain aspects, optionally greater than or equal to about 10 μm to less than or equal to about 200 μm.

In various aspects, negative electrode 22 may include a lithium-containing negative electroactive material, such as a lithium alloy and/or a lithium metal. For example, in certain variations, the negative electrode 22 may be defined by a lithium metal foil. In other variations, the negative electrode 22 may include, for example only, carbonaceous materials (such as, graphite, hard carbon, soft carbon, and the like) and/or metallic active materials (such as tin, aluminum, magnesium, germanium, and alloys thereof, and the like). In further variations, the negative electrode 22 may include a silicon-based electroactive material. In still further variations, the negative electrode 22 may be a composite electrode including a combination of negative electroactive materials. For example, the negative electrode 22 may include a first negative electroactive material and a second negative electroactive material. In certain variations, a ratio of the first negative electroactive material to the second negative electroactive material may be greater than or equal to about 5:95 to less than or equal to about 95:5. The first negative electroactive material may be a volume-expanding material including, for example, silicon, aluminum, germanium, and/or tin. The second negative electroactive material may include a carbonaceous material (e.g., graphite, hard carbon, and/or soft carbon) For example, in certain variations, the negative electroactive material may include a carbonaceous-silicon based composite including, for example, about 10 wt. % SiOₓ (where 0≤x≤2) and about 90 wt. % graphite. In each instance, the negative electroactive material may be prelithiated.

In certain variations, the negative electroactive material may be optionally intermingled (e.g., slurry casted) with an electronically conductive material (i.e., conductive additive) that provide an electron conductive path and/or a polymeric binder material that improve the structural integrity of the negative electrode 22. For example, the negative electrode 22 may include greater than or equal to about 30 wt. % to less than or equal to about 98 wt. %, and in certain aspects, optionally greater than or equal to about 60 wt. % to less than or equal to about 95 wt. %, of the negative electroactive material; greater than or equal to 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, and in certain aspects, optionally greater than or equal to about 0.5 wt. % to less than or equal to about 10 wt. %, of the polymeric binder.

Example polymeric binders include polyimide, polyamic acid, polyamide, polysulfone, polyvinylidene difluoride (PVdF), polytetrafluoroethylene (PTFE), polyacrylic acid (PAA), blends of polyvinylidene fluoride and polyhexafluoropropene, polychlorotrifluoroethylene, ethylene propylene diene monomer (EPDM) rubber, carboxymethyl cellulose (CMC), nitrile butadiene rubber (NBR), styrene-butadiene rubber (SBR), lithium polyacrylate (LiPAA), sodium polyacrylate (NaPAA), sodium alginate, and/or lithium alginate. Electronically conducting materials may include, for example, carbon-based materials, powdered nickel or other metal particles, or conductive polymers. Carbon-based materials may include, for example, particles of graphite, acetylene black (such as, KETCHEN™ black and/or DENKAm black), carbon nanofibers and nanotubes (such as, single wall carbon nanotubes (SWCNT), multiwall carbon nanotubes (MWCNT)), graphene (e.g., graphene platelets (GNP), and/or oxidized graphene platelets), conductive carbon blacks (such as, SuperP (SP)), and the like. Examples of a conductive polymer include polyaniline, polythiophene, polyacetylene, polypyrrole, and the like.

The positive electrode 24 is formed from a lithium-based active material that is capable of undergoing lithium intercalation and deintercalation, alloying and dealloying, or plating and stripping, while functioning as the positive terminal of a lithium-ion battery. The positive electrode 24 can be defined by a plurality of electroactive material particles. Such positive electroactive material particles may be disposed in one or more layers so as to define the three-dimensional structure of the positive electrode 24. The electrolyte 30 may be introduced, for example after cell assembly, and contained within pores of the positive electrode 24. In certain variations, the positive electrode 24 may include a plurality of solid-state electrolyte particles. In each instance, the positive electrode 24 may have an average thickness greater than or equal to about 20 μm to less than or equal to about 500 μm, and in certain aspects, optionally greater than or equal to about 60 μm to less than or equal to about 150 μm. In certain variations, for example, when the positive electrode 24 includes higher capacity materials (e.g., NCMA v. LFP), the positive electrode 24 may have a thinner average thickness. Further still, in power applications, the positive electrode 24 may have a thinner average thickness (e.g., greater than or equal to about 20 μm to less than or equal to about 80 μm), whereas in energy applications, the positive electrode 24 may have a thicker average thickness (e.g., greater than or equal to about 80 μm to less than or equal to about 120 μm).

In various aspects, the positive electrode 24 may be a nickel-rich cathode including a positive electroactive material represented by:

LiM¹ₓM²_{y}M³_{z}M⁴_{(1-x-y-z)}O₂

where M¹, M², M³, and M⁴ are each a transition metal (for example, each is independently selected from the group consisting of: nickel (Ni), manganese (Mn), cobalt (Co), aluminum (Al), iron (Fe), and combinations thereof), where 0≤x≤1, 0≤y≤1, and 0≤z≤1. For example, the positive electrode 24 may include NMC (LiNiₓCo_{y}Mn_{1-x-y}O₂, where 0.6≤x≤, 0≤y≤0.4) and/or NCA (LiNiₓCo_{y}Al_{1-x-y}O₂, where 0.6≤x≤1, 0≤y≤0.4) and/or NCMA (LiNiₓCo_{y}Mn_{z}Al_{1-x-y-z}O₂, where 0.6≤x≤1, 0≤y≤0.4, 0≤z≤0.4).

In other variations, the positive electroactive material may include a layered oxide represented by LiMeO₂, where Me is a transition metal, such as cobalt (Co), nickel (Ni), manganese (Mn), iron (Fe), aluminum (Al), vanadium (V), or combinations thereof (such as, LiNiO₂ (LNO) and/or LiCoO₂ (LCO)).

In still other variations, the positive electroactive material includes an olivine-type oxide represented by LiMePO₄, where Me is a transition metal, such as cobalt (Co), nickel (Ni), manganese (Mn), iron (Fe), aluminum (Al), vanadium (V), or combinations thereof.

In still other variations, the positive electroactive material includes a monoclinic-type oxide represented by Li₃Me₂(PO₄)₃, where Me is a transition metal, such as cobalt (Co), nickel (Ni), manganese (Mn), iron (Fe), aluminum (Al), vanadium (V), or combinations thereof.

In still other variations, the positive electroactive material includes a spinel-type oxide represented by LiMe₂O₄, where Me is a transition metal, such as cobalt (Co), nickel (Ni), manganese (Mn), iron (Fe), aluminum (Al), vanadium (V), or combinations thereof (such as LiNi_{0.5}Mn_{1.5}O₄ (LNMO)).

In still other variations, the positive electroactive material includes a tavorite represented by LiMeSO₄F and/or LiMePO₄F, where Me is a transition metal, such as cobalt (Co), nickel (Ni), manganese (Mn), iron (Fe), aluminum (Al), vanadium (V), or combinations thereof.

In still other variations, the positive electrode 24 may be a lithium-rich layered cathode including a positive electroactive material represented by:

xLi₂MnO₃·(1−x)LiMO₂

where M are transitions metals (for example, independently selected from the group consisting of: nickel (Ni), manganese (Mn), cobalt (Co), aluminum (Al), iron (Fe), and combinations thereof) and 0.01≤x≤0.99.

In still further variations, the positive electrode 24 may be a composite electrode including two or more positive electroactive material. For example, the positive electrode 24 may include a nickel-rich electroactive material, a layered oxide electroactive material, an olivine-type oxide electroactive material, a monoclinic-type oxide electroactive material, a spinel-type oxide, a tavorite electroactive material, and/or a lithium-rich electroactive material. In certain variations, the combination of positive electroactive materials may be like those detailed in U.S. patent application Ser. No. 17/552,522, titled “High Nickel Content Positive Electrodes Having Improved Thermal Stability,” to Bradley R. Frieberg, Xiaosong Huang, and Mark W. Verbrugge, filed Dec. 16, 2021, the entire disclosure of which is hereby incorporated by reference.

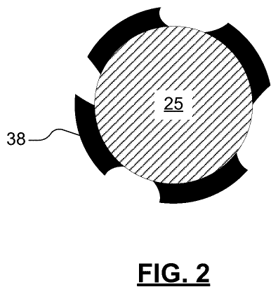

In each variation, at least some of the positive electroactive material particles defining the positive electrode 24 include a protective particle coating. Like the protective current collector coating 36, the protective electroactive material particle coating may be a carbon coating comprising a carbonaceous material selected from the group consisting of: graphite, graphene, carbon black, soft carbon, hard carbon, carbon fibers, carbon nanotubes, mesoporous carbon materials, biomass derived carbon materials, and combinations thereof. As illustrated, in FIG. 2, the protective electroactive material particle coating 38 may be a discontinuous coating. In certain variations, the protective electroactive material particle coating 28 may covers greater than or equal to about 0% to less than or equal to about 100%, and in certain aspects, optionally greater than or equal to about 30% to less than or equal to about 70%, of a total surface area of the electroactive material particle 25. The protective electroactive material particle coating 38 may have an average thickness greater than or equal to about 0 nm to less than or equal to about 1,000 nm, and in certain aspects, optionally greater than or equal to about 10 nm to less than or equal to about 100 nm. The protective electroactive material particle coating 38 may help to improve the thermal stability of the positive electrode 24. For example, in the instance of nickel-rich cathodes, which are thermally unstable, the reduction of Ni⁴⁺ to Ni²⁺ at higher temperatures can cause the release of oxygen, which can cause severe thermal events by reacting with the electrolyte 30. The protective electroactive material particle coating 38 may also lower or reduce resistance in the positive electrode 24, for example, at least in part because the coating layer has higher electronic conductivity. Similar to the protective coating 36 discussed above, the protective electroactive material particle coating 38 similarly helps to reduce contact resistance at the at the positive electrode 24 to positive electrode current collector 34 interface, while permitting the electrolyte 30 to wet the pore volume.

In various aspects, the present disclosure provides methods for forming protective electroactive material particle coatings, like the protective electroactive material particle coating 38 illustrated in FIG. 2. In certain variations, the protective electroactive material particle coatings may be formed using sol-gel methods. In other variations, the protective electroactive material particle coatings may be formed using mechanical processes, such as acoustic mixers. For example, the positive electroactive material particles 25 may be mechanically mixed using an acoustic mixer for a first period of time (e.g., greater than or equal to about minutes to less than or equal to about 20 minutes), and following the mixing, calcinated at a selected temperature (e.g., greater than 250° C.) for a second period of time (e.g., about 3 hours). In still other variations, the protective electroactive material particle coatings may be formed using chemical vapor deposition (CVD) processes and/or processes that include the pyrolysis of adsorbed organic compounds, and/or in-situ formation of protective electroactive particle coatings along with the formation of electrode material.

With renewed reference to FIG. 1, in various aspects, the positive electroactive material may be optionally intermingled (e.g., extruded or slurry casted) with an electronically conductive material (i.e., conductive or carbon additive) that can help to provide an electron conductive path in the positive electrode 24. For example, the positive electrode 24 may include greater than or equal to about 50 wt. % to less than or equal to about 99 wt. %, optionally greater than or equal to about 90 wt. % to less than or equal to about 99 wt. %, and in certain aspects, optionally greater than or equal to about 97 wt. % to less than or equal to about 99 wt. %, of the positive electroactive material; and greater than or equal to about 0 wt. % to less than or equal to about 30 wt. %, and in certain aspects, optionally greater than or equal to about 0.5 wt. % to less than or equal to about 5 wt. %, of the carbon additive.

The conductive additive included in the positive electrode 24 may be the same as or different form the conductive additive included in the negative electrode 22. For example, in certain variations, conductive additive included in the positive electrode 24 may include carbon-based materials, powdered nickel or other metal particles, and/or conductive polymers. The carbon-based materials may include, for example, particles of graphite, acetylene black (such as DENKA™ black), carbon black (such as KETJEN™ black and/or Super C45 or C65), carbon fibers and nanotubes, graphene, and the like. Examples of a conductive polymer include polyaniline, polythiophene, polyacetylene, polypyrrole, and the like.

In certain variations, the conductive additive may include two or more conductive additives. For example, the positive electrode 24 may include greater than or equal to about 0.25 wt. to less than or equal to about 10, and in certain aspects, optionally greater than or equal to about 0.5 wt. to less than or equal to about 5 wt. %, of a first conductive additive and/or greater than or equal to about 0.1 wt. to less than or equal to about 10 wt. %, and in certain aspects, optionally greater than or equal to about 0.5 wt. to less than or equal to about 5 wt. %, of a second conductive additive and/or and greater than or equal to about 0.05 wt. to less than or equal to about 2 wt. %, and in certain aspects, optionally greater than or equal to about 0.05 wt. to less than or equal to about 1 wt. %, of a third conductive additive.

In certain variations, the two or more conductive additives may be carbon additives having different aspect ratios. For example, a first conductive carbon additive may have a first aspect ratio that is greater than or equal to about 1:1 to less than or equal to about 3:1, and a gravimetric surface area greater than or equal to about 45 m²/g to less than or equal to about 300 m²/g. The first conductive carbon additive may include acetylene black (AB) and/or carbon black (CB).

A second conductive carbon additive comprising, for example only, graphene nanoplatelets (GNP), conductive graphite particles, and/or exfoliated graphite sheets may have a second aspect ratio of greater than or equal to about 3:1 to less than or equal to about 500:1. The second conductive carbon additives may have average diameters greater than or equal to about 1 μm to less than or equal to about 25 μm and average thicknesses greater than or equal to about 5 nm to less than or equal to about 100 nm (corresponding, for example, to a stack of about 15 to about 300 graphene layers). The second conductive carbon additive may exhibit a surface area greater than or equal to about 10 m²/g to less than or equal to about 200 m²/g.

A third conductive carbon additive comprising, for example only, carbon nanotubes (CNT) and/or carbon nanofibers (CF) may have aspect ratio greater than or equal to about 20:1 to less than or equal to about 10,000:1, and a gravimetric surface area greater than or equal to about 200 m²/g to less than or equal to about 1300 m²/g.

In certain variations, the two or more conductive additives may be electrically conductive carbon additive types like those detailed in U.S. patent application Ser. No. 17/476,833, entitled “Positive Electrodes Including Electrically Conductive Carbon Additives,” to Bradley R. Frieberg, et al., filed Sep. 16, 2021, the entire disclosure of which is hereby incorporated by reference.

In various aspects, the positive electroactive material may be optionally intermingled (e.g., extruded or slurry casted) with a polymeric binder material that can help to improve the structural integrity of the positive electrode 24. For example, the positive electrode 24 may include greater than or equal to about 0 wt. % to less than or equal to about 30 wt. %, and in certain aspects, optionally greater than or equal to about 0.8 wt. % to less than or equal to about 5 wt. %, of the polymeric binder material.

The polymeric binder material as included in the positive electrode 24 may be the same as or different from the polymeric binder material as included in the negative electrode 22. For example, the polymeric binder material included in the positive electrode 24 may include polyimide, polyamic acid, polyamide, polysulfone, polyvinylidene difluoride (PVdF), polytetrafluoroethylene (PTFE), polyacrylic acid (PAA), copolymers of vinylidene fluoride (VdF) and hexafluoropropene (HFP), copolymers of vinylidene fluoride (VdF) and tetrafluoroethylene (TFE), polychlorotrifluoroethylene, ethylene propylene diene monomer (EPDM) rubber, carboxymethyl cellulose (CMC), nitrile butadiene rubber (NBR), styrene-butadiene rubber (SBR), lithium polyacrylate (LiPAA), sodium polyacrylate (NaPAA), sodium alginate, lithium alginate, and their blends.

In various aspects, the positive electroactive material may be optionally intermingled (e.g., extruded or slurry cased) with a polymer dispersant additive that can help to stabilize and/or disperse the positive electroactive materials and/or conductive fillers. The polymeric binders functionalized with acid co-monomers have sulfonic or carboxylic acid groups (i.e., polymer dispersant additive) may adsorb more strongly to high nickel electroactive material as a result of H⁺/Li⁺ exchange, which then may provide colloidal stability of the concentrated coating slurry. In certain variations, the polymeric dispersant additive (such as polyvinylidene fluoride (PVDF) co-polymers, sulfonated poly(p-phenylene), and/or polyvinylpyridine) may be used to stabilize the conductive carbon particle dispersion. Polymeric dispersant additives that are also functionalized with aromatic co-monomers may adsorb more strongly to the conductive carbon particle surface due to 7r-orbital bonding, which can provide colloidal stability for this component in the concentrated coating slurry. In each instance, the positive electrode 24 may include greater than or equal to about 0 wt. % to less than or equal to about 15 wt. %, and in certain aspects, optionally greater than or equal to about 0.2 wt. % to less than or equal to about 5 wt. %, of the polymer dispersant additive to improve the colloidal stability for the positive electrode particle dispersion.

In various aspects, the positive electroactive material may be optionally intermingled with a sulfonate aromatic ionomer additive, for example, to improve the colloidal stability of both the electroactive material particle and the conductive carbon particle dispersion for a concentrated positive electrode slurry as detailed in U.S. patent application Ser. No. 17/591,740, entitled “Additives for High-Nickel Electrodes and Methods of Forming the Same,” to Roland J. Koestner, et al., filed Feb. 3, 2022, the entire disclosure of which is hereby incorporated by reference.

Certain features of the current technology are further illustrated in the following non-limiting examples.

### Example 1

Example batteries and battery cells may be prepared in accordance with various aspects of the present disclosure.

For example, a first example cell 310 may include a protective current collector coating disposed on one or more surfaces of a positive electrode current collector in accordance with various aspects of the present disclosure. The positive electrode assembled with the positive electrode current collector in the first example cell 310 may include NCMA (LiNiₓCo_{y}Mn_{z}Al_{1-x-y-z}O₂, where 0.6≤x≤1, 0≤y≤0.4, 0≤z≤0.4).

A first comparative cell 330 may similarly include a positive electrode including NCMA (LiNiₓCo_{y}Mn_{z}Al_{1-x-y-z}O₂, where 0.6≤x≤1, 0≤y≤0.4, 0≤z≤0.4). However, the positive electrode assembly of the first comparative cell 330 does not include the protective current collector coating.

A second example cell 320 may include a protective current collector coating disposed on one or more surfaces of a positive electrode current collector in accordance with various aspects of the present disclosure. The positive electrode assembled with the positive electrode current collector in the second example cell 320 may include NCMA (LiNiₓCo_{y}Mn_{z}Al_{1-x-y-z}O₂, where 0.6≤x≤1, 0≤y≤0.4, 0≤z≤0.4).

A second comparative cell 340 may similarly include a positive electrode including NCMA (LiNiₓCo_{y}Mn_{z}Al_{1-x-y-z}O₂, where 0.6≤x≤1, 0≤y≤0.4, 0≤z≤0.4). However, the positive electrode assembly of the second comparative cell 340 does not include the protective current collector coating.

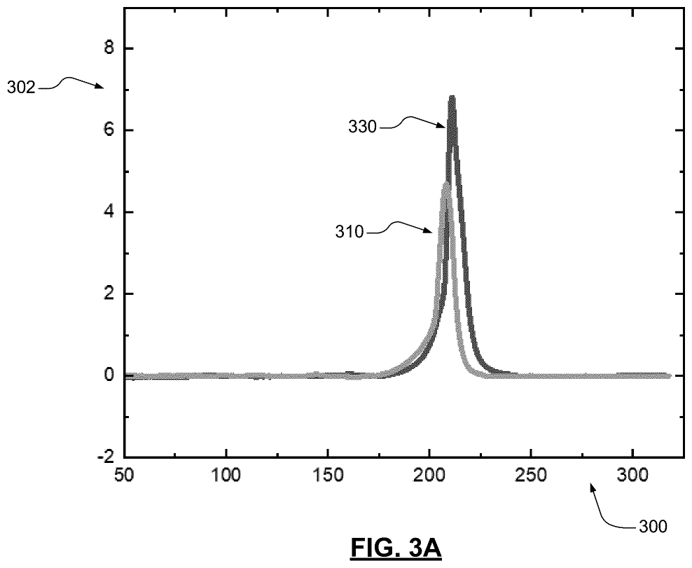

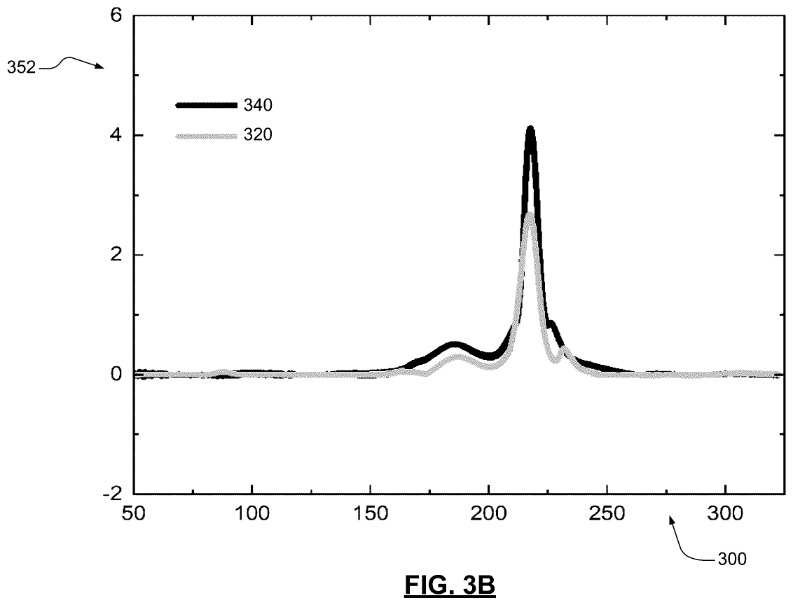

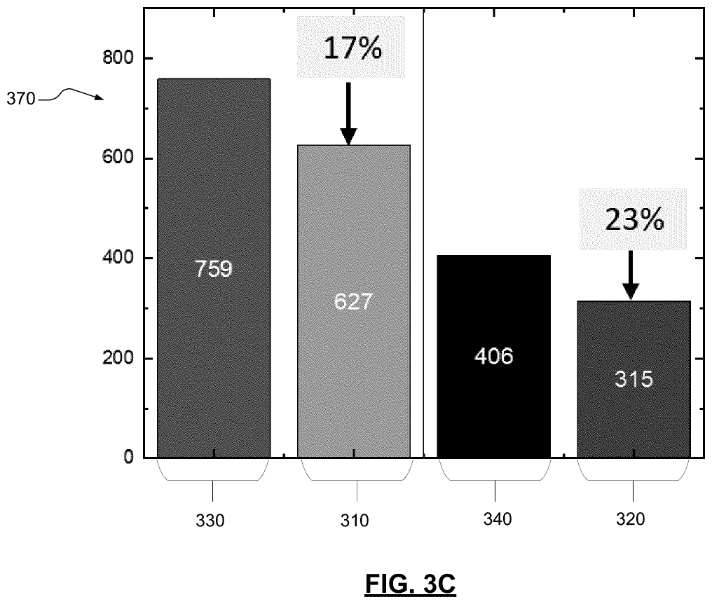

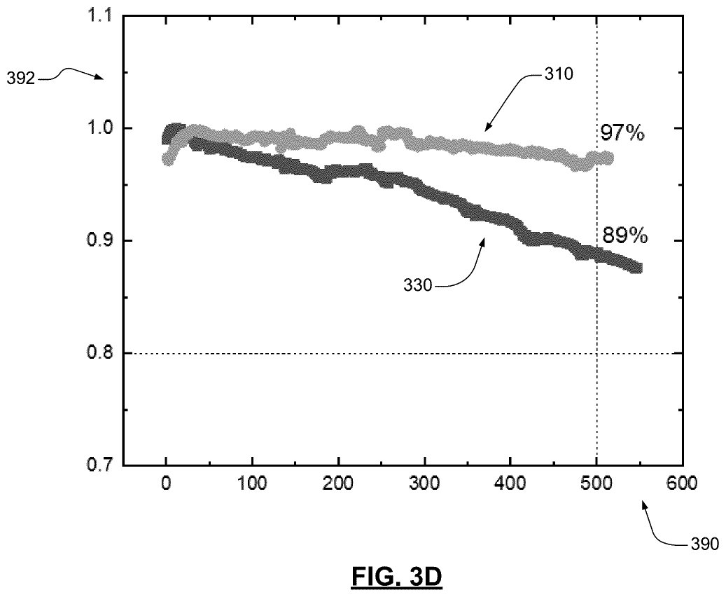

FIG. 3A is a graphical illustration demonstrating the heat generation of the first example cell 310 as compared to the first comparative cell 330, where the x-axis 300 represents temperature (° C.), and the y-axis 302 represents heat flow (mW/mg). As illustrated, the first example cell 310 shows a heat generation reduction as compared to the first comparative cell 330.

FIG. 3B is a graphical illustration demonstrating the heat generation of the second example cell 320 as compared to the second comparative cell 340, where the x-axis 350 represents temperature (° C.), and the y-axis 352 represents heat flow (mW/mg). As illustrated, the second example cell 320 shows a heat generation reduction as compared to the second comparative cell 340.

FIG. 3C is a graphical illustrating demonstrating the heat generation of the first example cell 310 as compared to the first comparative cell 330, and also, the second example cell 320 as compared to the second comparative cell 340, where the y-axis 370 represents heat release (J/g). As illustrated, the first example cell 310 has a heat generation reduction of about 17% as compared to the first comparative cell 330, and the second example cell 320 has a heat generation reduction of about 23% as compared to the second comparative cell 340

FIG. 3D is a graphical illustration demonstrating the capacity retention of the first example cell 310 as compared to the first comparative cell 330, where the x-axis 890 represents the number of cycles, and the y-axis 892 represents capacity retention (%). As illustrated, after 500 cycles, the first example cell 310 has a capacity retention of about 97%, while the first comparative cell 330 has a capacity retention of only 89%.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrode assembly for use in an electrochemical cell that cycles lithium ions, the electrode assembly comprising:
a current collector;
a protective coating disposed near or adjacent to a surface of the current collector, the protective coating being a carbon layer comprising a carbonaceous material selected from the group consisting of: graphite, graphene, carbon black, soft carbon, hard carbon, carbon fibers, carbon nanotubes, mesoporous carbon materials, biomass-derived carbon materials, and combinations thereof; and
an electroactive material layer disposed near or adjacent to a surface of the protective coating opposite to the current collector.

2. The electrode assembly of claim 1, wherein the protective coating is a continuous coating covering greater than or equal to about 85% of the surface of the current collector.

3. The electrode assembly of claim 1, wherein the protective coating has an average thickness greater than 0 micrometer to less than or equal to about 20 micrometers.

4. The electrode assembly of claim 1, wherein the current collector comprises an electrically conductive material selected from the group consisting of: aluminum (Al), copper (Cu), nickel (Ni), titanium (Ti), stainless steel (SS), and combinations thereof.

5. The electrode assembly of claim 1, wherein the electroactive material layer is defined by a plurality of electroactive material particles, at least a portion of the electroactive material particles of the plurality comprising a protective particle coating.

6. The electrode assembly of claim 5, wherein the carbonaceous material is a first carbonaceous material, and the protective particle coating is a carbon coating comprising a second carbonaceous material selected from the group consisting of: graphite, graphene, carbon black, soft carbon, hard carbon, carbon fibers, carbon nanotubes, mesoporous carbon materials, biomass derived carbon materials, and combinations thereof.

7. The electrode assembly of claim 6, wherein the first carbonaceous material is the same as the second carbonaceous material.

8. The electrode assembly of claim 5, wherein the protective particle coating is a continuous or discontinuous coating covering greater than 0% to less than or equal to about 100% of a total surface area of each electroactive material particle of the plurality of electroactive material particles.

9. The electrode assembly of claim 5, wherein the protective particle coating has an average thickness greater than 0 nanometers to less than or equal to about 1,000 nanometers.

10. The electrode assembly of claim 5, wherein the electroactive material particles of the plurality of electroactive material particles comprise a nickel-rich electroactive material represented by:
LiM¹ₓM²_{y}M³_{z}M⁴_{(1-x-y-z)}O₂
where M¹, M², M³, and M⁴ are each a transition metal independently selected from the group consisting of: nickel (Ni), manganese (Mn), cobalt (Co), aluminum (Al), iron (Fe), and combinations thereof, where 0≤x≤1, 0≤y≤1, and 0≤z≤1.

11. The electrode assembly of claim 1, wherein the electroactive material layer comprises greater than or equal to about 50 wt. % to less than or equal to about 99 wt. % of an electroactive material, and greater than or equal to about 0.5 wt. % to less than or equal to about 30 wt. % of a conductive additive, the conductive additive comprising a first conductive additive having a first aspect ratio and a second conductive additive having a second aspect ratio, the first and second aspect ratios being different.

12. The electrode assembly of claim 1, wherein the electroactive material layer comprises greater than or equal to about 50 wt. % to less than or equal to about 99 wt. % of an electroactive material, and greater than or equal to about 0.2 wt. % to less than or equal to about 15 wt. % of a polymer dispersant additive selected from the group consisting of: acid-functionalized polyvinylidene fluoride (PVDF) co-polymers, acid-functionalized sulfonated poly(p-phenylene), acid-functionalized polyvinylpyridine, and combinations thereof.

13. An electrode assembly for use in an electrochemical cell that cycles lithium ions, the electrode assembly comprising:
a current collector; and
an electroactive material layer disposed near or adjacent to a surface of the current collector, the electroactive material layer defined by a plurality of electroactive material particles, at least a portion of the electroactive material particles of the plurality of electroactive material particles comprising a protective particle coating, the protective particle coating being a carbon coating comprising a carbonaceous material selected from the group consisting of: graphite, graphene, carbon black, soft carbon, hard carbon, carbon fibers, carbon nanotubes, mesoporous carbon materials, biomass derived carbon materials, and combinations thereof.

14. The electrode assembly of claim 13, wherein the protective particle coating is a continuous or discontinuous coating covering greater than 0% to less than or equal to about 100% of a total surface area of the at least a portion of the electroactive material particles, and having an average thickness greater than 0 nanometers to less than or equal to about 1,000 nanometers.

15. The electrode assembly of claim 13, wherein the carbonaceous material is a first carbonaceous material, and the surface of the current collector comprises a protective coating, the protective coating being a continuous carbon coating that covers greater than or equal to about 85% of the surface of the current collector and comprising a second carbonaceous material selected from the group consisting of: graphite, graphene, carbon black, soft carbon, hard carbon, carbon fibers, carbon nanotubes, mesoporous carbon materials, biomass derived carbon materials, and combinations thereof, the second carbonaceous material being the same as or different from the first carbonaceous material.

16. The electrode assembly of claim 13, wherein the protective coating has an average thickness greater than 0 micrometers to less than or equal to about 20 micrometers.

17. An electrode assembly for use in an electrochemical cell that cycles lithium ions, the electrode assembly comprising:
a current collector;
an electroactive material layer disposed parallel with the current collector, the electroactive material layer defined by a plurality of electroactive material particles and conductive additive dispersed with the electroactive material particles, at least a portion of the electroactive material particles of the plurality of electroactive material particles comprising a protective particle coating, the protective particle coating being a carbon coating comprising a first carbonaceous material, and the conductive additive conductive additive comprising a first conductive additive having a first aspect ratio and a second conductive additive having a second aspect ratio, the first and second aspect ratios being different; and
a protective coating disposed between the current collector and the electroactive material layer, the protective coating being a carbon layer comprising a second carbonaceous material, the first and second carbonaceous materials being independently selected from the group consisting of: graphite, graphene, carbon black, soft carbon, hard carbon, carbon fibers, carbon nanotubes, mesoporous carbon materials, biomass derived carbon materials, and combinations thereof.

18. The electrode assembly of claim 17, wherein the protective particle coating is a continuous or discontinuous coating covering greater than 0% to less than or equal to about 100% of a total surface area of the as least a portion of the electroactive material particles, and having an average thickness greater than 0 nanometers to less than or equal to about 1,000 nanometers.

19. The electrode assembly of claim 17, wherein the protective coating is a continuous coating covering greater than or equal to about 85% of the surface of the current collector and has an average thickness greater than 0 micrometers to less than or equal to about 20 micrometers.

20. The electrode assembly of claim 17, wherein the electroactive material layer comprises greater than or equal to about 50 wt. % to less than or equal to about 99 wt. % of the electroactive material particles; greater than or equal to about 0.5 wt. % to less than or equal to about 30 wt. % of the conductive additive; and greater than or equal to about 0.2 wt. % to less than or equal to about 15 wt. % of a polymer dispersant additive selected from the group consisting of: acid-functionalized polyvinylidene fluoride (PVDF) co-polymers, acid-functionalized sulfonated poly(p-phenylene), acid-functionalized polyvinylpyridine, and combinations thereof.
